(19) United States
(12) Patent Application Publication
(10) Pub. No.: US 2016/0207255 A1
(43) Pub. Date: Jul. 21, 2016

(54) ENCAPSULATION STRUCTURE FOR CONTAINER

(71) Applicant: TAIWAN FOREVER INDUSTRY CO., LTD., TAIPEI CITY (TW)

(72) Inventor: HSIEN-LIANG CHANG, TAIPEI CITY (TW)

(21) Appl. No.: 14/597,317

(22) Filed: Jan. 15, 2015

(51) Int. Cl. B29C 65/48; B65D 53/06; B29C 65/02

(52) U.S. Cl. CPC B29C 65/483; B29C 65/02; B65D 53/06; B29L 2031/565

(57) ABSTRACT

An encapsulation structure for a container comprising a sealing layer, having an aluminum layer and a heat-sealing adhesive layer, wherein the aluminum layer is sealed on a rim of the container by the heat-sealing adhesive layer; a strippable foamed-plastic layer deposited in a cap of the container; and a strippable adhesive layer, wherein the strippable foamed-plastic layer is adhered to the aluminum layer by the strippable adhesive layer, and the adhesion force of the strippable adhesive layer is smaller than that of the heat-sealing adhesive layer. Therefore, the encapsulation structure for a container may be environmentally friendly, reduce used materials, be partially recyclable, and securely seal the container.

### FIELD OF TECHNOLOGY

The invention relates to an encapsulation structure for a container, and more particularly, to an encapsulation structure for a container that is environmentally friendly, reduces used materials, may be partially recyclable, and may securely seal the container.

### BACKGROUND

Before conventional encapsulation structures for containers are heated by electromagnetic induction, a foamed-plastic layer, a paper layer, a wax layer, a plastic protective film, an aluminum layer, and a heat-sealing adhesive layer are sequentially arranged from the cap to the rim; after being heated by electromagnetic induction, the wax layer melts and is absorbed by the paper layer, and the aluminum layer is sealed on the rim by the heat-sealing adhesive layer and the foamed-plastic layer is deposited in the cap. However, since conventional encapsulation structures for containers use wax layers that are not readily decomposable, they are not environmentally friendly; in addition, due to the usage of such wax layers in conventional encapsulation structures for containers, paper layers are required to be added to absorb the melted wax layers, which further consumes more materials. Furthermore, as conventional encapsulation structures for containers use wax layers, after the paper layer absorbs the melted wax layer, the conventional encapsulation structure may become moldy when used in containers with liquid, and thus the foamed-plastic layers of conventional encapsulation structures may not be recycled; moreover, as conventional encapsulation structures for containers use wax layers, the adhesion of such wax layers may be improperly stripped off due to the temperature of shipment or storage being too high. In addition, since conventional encapsulation structures for containers have poor heat conduction for rims of large areas, it is difficult for the wax layer to melt and causes the wax layer to be difficult to be stripped off and the cap to be unable to open.

Therefore, an encapsulation structure for a container that is environmentally friendly, reduces used materials, may be partially recyclable, and may securely seal the container shall be disclosed by the present invention.

### SUMMARY

In view of the above shortcomings of prior art, great research effort was devoted to overcome such imperfections, and an encapsulation structure for a container that achieves the purposes of being environmentally friendly, reducing used materials, being partially recyclable, and securely sealing the container is developed.

To achieve the above and other purposes, an encapsulation structure for a container in the present invention is provided to comprise: a sealing layer, having an aluminum layer and a heat-sealing adhesive layer, wherein the aluminum layer is sealed on a rim of the container by the heat-sealing adhesive layer; a strippable foamed-plastic layer, deposited in a cap of the container; and a strippable adhesive layer, wherein the strippable foamed-plastic layer is adhered to the aluminum layer by the strippable adhesive layer, and the adhesion force of the strippable adhesive layer is smaller than the adhesion force of the heat-sealing adhesive layer.

In the above encapsulation structure for a container, a plastic protective film is deposited on top of the aluminum layer, and the strippable foamed-plastic layer is adhered to the plastic protective film by the strippable adhesive layer.

In the above encapsulation structure for a container, the plastic protective film is transparent.

In the above encapsulation structure for a container, a pattern layer is deposited on top of the strippable foamed-plastic layer and the pattern layer faces the aluminum layer.

In the above encapsulation structure for a container, a pattern layer is deposited on top of the strippable foamed-plastic layer and the pattern layer faces the plastic protective film.

In the above encapsulation structure for a container, the strippable adhesive layer is a strippable polyurethane (PU) adhesive layer.

By the above embodiments, the encapsulation structure for a container of the present invention may be environmentally friendly, reduce used materials, be partially recyclable, and securely seal the container.

### BRIEF DESCRIPTION

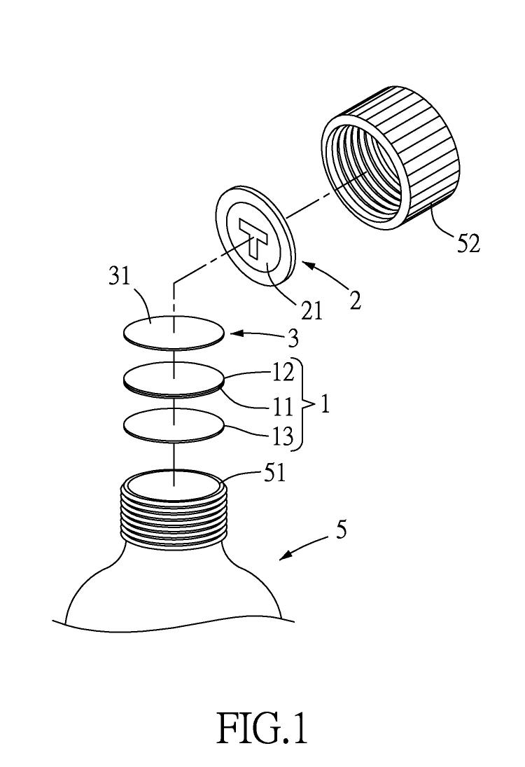

FIG. 1 is an exploded diagram of a preferred embodiment of the invention;

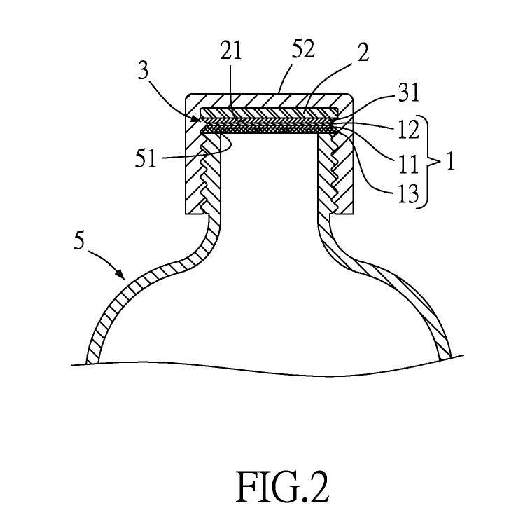

FIG. 2 is a cross-section assembly diagram of a preferred embodiment of the invention.

### DETAILED DESCRIPTION

The purposes, features, and effects of the invention may be more fully understood by the subsequent detailed description and embodiments with references made to the accompanying drawings.

As shown in FIG. 1 and FIG. 2, the invention provides an encapsulation structure for a container comprising a sealing layer 1, a strippable foamed-plastic layer 2, and a strippable adhesive layer 3. The sealing layer 1 has an aluminum layer 11 and a heat-sealing adhesive layer 13, wherein the aluminum layer 11 is sealed on a rim 51 of the container 5 by the heat-sealing adhesive layer 13, and the heat-sealing adhesive layer 13 may be positioned on a periphery below the aluminum layer 11 to correspondingly adhere to a periphery on the rim 51; the strippable foamed-plastic layer 2 is deposited in a cap 52 of the container 5, wherein the strippable foamed-plastic layer 2 is adhered to the aluminum layer 11 by the strippable adhesive layer 3, and the adhesion force of the strippable adhesive layer 3 is smaller than that of the heat-sealing adhesive layer 13. Before the encapsulation structure for a container of the present invention is heated by electromagnetic induction, the aluminum layer 11 is sealed on the rim 51 by the heat-sealing adhesive layer 13, and the strippable foamed-plastic layer 2 is subsequently adhered to the aluminum layer 11 by the strippable adhesive layer 3, and finally the cap 52 of the container 5 is covered on the strippable foamed-plastic layer 2 so that the strippable foamed-plastic layer 2 is deposited in the cap 52 of the container 5. Subsequently, the container 5, the encapsulation structure of the present invention, and the cap 52 of the container 5 are heated by electromagnetic induction so that the heat-sealing adhesive layer 13 securely seals the aluminum layer 11 on the rim 51; when the container 5 is acquired by a user and the cap 52 is opened, since the adhesion force of the strippable adhesive layer 3 is smaller than that of the heat-sealing adhesive layer 13, the strippable foamed-plastic layer 2 may be separated from the sealing layer 1 along with the cap 52.

As described in above, as the encapsulation structure of the present invention does not use wax, it is environmentally friendly; in addition, as the encapsulation structure of the present invention does not use wax, a paper layer is also not required to be used in the encapsulation structure of the present invention, and thus used materials may be reduced. Furthermore, as the encapsulation structure of the present invention does not use wax, the strippable foamed-plastic layer 2 does not have to contain paper and may be recycled; moreover, as the encapsulation structure of the present invention uses the strippable adhesive layer 3 instead of wax, the encapsulation structure of the present invention is less affected by temperature and may have more stable adhesion force to securely seal the rim 51 and facilitate the opening of the cap 52.

Further referring to FIG. 1 and FIG. 2, as can be seen, a plastic protective film 12 may be deposited on top of the aluminum layer 11 in the above encapsulation structure to protect the aluminum layer 11, and the strippable foamed-plastic layer 2 may be adhered to the plastic protective film 12 by the strippable adhesive layer 3. Therefore, before the encapsulation structure for a container of the present invention is heated by electromagnetic induction, the aluminum layer 11 and the plastic protective film 12 are sealed on the rim 51 by the heat-sealing adhesive layer 13, and the strippable foamed-plastic layer 2 is subsequently adhered to the plastic protective film 12 on the aluminum layer 11 by the strippable adhesive layer 3, and finally the cap 52 of the container 5 is covered on the strippable foamed-plastic layer 2 so that the strippable foamed-plastic layer 2 is deposited in the cap 52 of the container 5. Subsequently, the container 5, the encapsulation structure of the present invention, and the cap 52 of the container 5 are heated by electromagnetic induction so that the heat-sealing adhesive layer 13 securely seals the aluminum layer 11 and the plastic protective film 12 on the rim 51; when the container 5 is acquired by a user and the cap 52 is opened, since the adhesion force of the strippable adhesive layer 3 is smaller than that of the heat-sealing adhesive layer 13, the strippable foamed-plastic layer 2 may be separated from the sealing layer 1 along with the cap 52.

Further referring to FIG. 1 and FIG. 2, as can be seen, the plastic protective film 12 may be transparent to reveal the aluminum layer 11 in the above encapsulation structure for a container.

Further referring to FIG. 1 and FIG. 2, as can be seen, a pattern layer 21 may be deposited on top of the strippable foamed-plastic layer 2 in the above encapsulation structure for a container, and the pattern layer 21 may face the aluminum layer 11 when there is no plastic protective film 12 on the aluminum layer 11, and the pattern layer 21 may face the plastic protective film 12 when there is a plastic protective film 12 on the aluminum layer 11. The pattern layer 21 may be text, images, or their combination. Therefore, after the strippable foamed-plastic layer 2 is opened, messages may be displayed by the pattern layer 21.

Further referring to FIG. 1 and FIG. 2, as can be seen, the strippable adhesive layer 3 may be a strippable polyurethane (PU) adhesive layer 31 in the above encapsulation structure for a container. Therefore, the strippable PU adhesive layer 31 may adjust the adhesive strength (10 g/15 mm-200 g/15 mm) by its composition; in addition, since the strippable PU adhesive layer 31 has heat tolerance up to above 70° C., the strippable PU adhesive layer 31 may avoid damaging during the electromagnetic induction heating process. In another embodiment, the strippable adhesive layer 3 may also be a strippable water-based adhesive layer.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An encapsulation structure for a container, comprising:
a sealing layer, having an aluminum layer and a heat-sealing adhesive layer, wherein the aluminum layer is sealed on a rim of the container by the heat-sealing adhesive layer;
a strippable foamed-plastic layer, deposited in a cap of the container; and
a strippable adhesive layer, wherein the strippable foamed-plastic layer is adhered to the aluminum layer by the strippable adhesive layer, and the adhesion force of the strippable adhesive layer is smaller than the adhesion force of the heat-sealing adhesive layer.

2. The encapsulation structure for a container as claimed in claim 1, wherein a plastic protective film is deposited on top of the aluminum layer, and the strippable foamed-plastic layer is adhered to the plastic protective film by the strippable adhesive layer.

3. The encapsulation structure for a container as claimed in claim 2, wherein the plastic protective film is transparent.

4. The encapsulation structure for a container as claimed in claim 1, wherein a pattern layer is deposited on top of the strippable foamed-plastic layer and the pattern layer faces the aluminum layer.

5. The encapsulation structure for a container as claimed in claim 2, wherein a pattern layer is deposited on top of the strippable foamed-plastic layer and the pattern layer faces the plastic protective film.

6. The encapsulation structure for a container as claimed in claim 1, wherein the strippable adhesive layer is a strippable polyurethane (PU) adhesive layer.
